(19) United States
(12) Patent Application Publication
(10) Pub. No.: US 2016/0353407 A1
(43) Pub. Date: Dec. 1, 2016

(54) METHODS AND SYSTEMS FOR NOTIFICATION MANAGEMENT BETWEEN AN ELECTRONIC DEVICE AND A WEARABLE ELECTRONIC DEVICE

(71) Applicant: Noodoe Corporation, Taipei City (TW)

(72) Inventors: Chih-Feng Hsu, Taipei City (TW); Li-Hui Chen, Taipei City (TW); John C. Wang, Taipei City (TW)

(21) Appl. No.: 15/149,275

(22) Filed: May 9, 2016

(30) Foreign Application Priority Data
May 29, 2015 (TW) 104117403

(51) Int. Cl. H04W 68/00; H04W 68/02

(52) U.S. Cl. CPC H04W 68/005; H04W 68/02

(57) ABSTRACT

Methods and systems for notification management between an electronic device and a wearable electronic device are provided. First, when an event occurs in a wearable electronic device, the wearable electronic device generates a command, and transmits the command to an electronic device via a wireless network. In response to the command, the electronic device obtains notification data, and transmits the notification data to the wearable electronic device via the wireless network.

### BACKGROUND OF THE INVENTION

Field of the Invention

The disclosure relates generally to notification management methods and systems, and, more particularly to methods and systems that can appropriately manage the notifications between an electronic device and a wearable electronic device.

Description of the Related Art

Recently, electronic devices, such as smart phones, tablets, notebooks, and other portable devices, have become more and more technically advanced and multifunctional. For example, portable devices have network connectivity capabilities. Users can use their portable devices to connect to networks at anytime and anywhere. The convenience and new functionalities advanced by modern technology have made these devices into necessities of life.

Furthermore, with the coming of IOT (Internet Of Things) generation, every device or object can connect to networks, and users can access and control these devices or objects via networks. Currently, wearable electronic devices have become the most tangible applications of IOT. In some cases, the wearable device can detect health information of a user, record exercise information and sleep patterns, or display email messages or incoming calls notifications.

However, since there is a size limitation to wearable electronic devices, the battery capacity and battery life of the devices are high priority issues in the industry. In some cases of network communication, a smart phone can transmit related notifications, such as email messages or incoming calls to the wearable electronic device via a wireless network. Since any communication between the smart phone and the wearable electronic device consumes the power of the wearable electronic device, the power usage efficiency of the wearable electronic device can be improved if the communications between the smart phone and the wearable electronic device are appropriately managed. In some cases, the transmission of the communications between the smart phone and the wearable electronic device may be unnecessary. For example, when a user does not currently wear a wearable electronic device, the process of transmitting related notifications to the wearable electronic device may be redundant. Furthermore, the increased power consumption of the wearable electronic device is also wasted.

### BRIEF SUMMARY OF THE INVENTION

Methods and systems for notification management between an electronic device and a wearable electronic device are provided, wherein the notifications between the electronic device, such as a smart phone and the wearable electronic device can be appropriately managed.

In an embodiment of a method for notification management between an electronic device and a wearable electronic device, when an event occurs in a wearable electronic device, a command is generated and the command is transmitted to an electronic device via a wireless network by the wearable electronic device. In response to the command, notification data is obtained, and the notification data is transmitted to the wearable electronic device via the wireless network by the electronic device.

An embodiment of a system for notification management between an electronic device and a wearable electronic device comprises a wearable electronic device and an electronic device. When an event occurs, the wearable electronic device generates a command, and transmits the command to the electronic device via a wireless network. The electronic device receives the command, obtains notification data according to the received command, and transmits the notification data to the wearable electronic device via the wireless network.

In some embodiments, the event comprises a reception of an input by the wearable electronic device via an input unit, and/or an activation for a component of the wearable electronic device.

In some embodiments, the electronic device records specific notification data which has been transmitted to the wearable electronic device. The electronic device determines whether the obtained notification data is identical to the specific notification data. When the obtained notification data is identical to the specific notification data, the electronic device does not transmit the notification data to the wearable electronic device. When the obtained notification data is not identical to the specific notification data, the electronic device transmits the notification data to the wearable electronic device, and sets the notification data as the specific notification data.

In some embodiments, the notification data is obtained from a status bar of the electronic device, wherein the status bar displays notification contents for at least one of a plurality of applications in the electronic device. In some embodiments, an interface is provided for selecting at least one specific application from the applications, wherein when the status bar comprises the notification content corresponding to the specific application, the electronic device obtains the notification content corresponding to the specific application as the notification data.

In some embodiments, when the wearable electronic device receives the notification data from the electronic device, a prompt is generated via the wearable electronic device, wherein the prompt comprises a vibration, and/or data displayed in a display unit of the wearable electronic device.

In some embodiments, the wearable electronic device receives an operational command. In response to the operational command, the wearable electronic device displays a specific interface via a display unit of the wearable electronic device, and displays the notification data in the specific interface. In some embodiments, the operational command comprises an input corresponding to an input unit, a detection result for an object of a proximity sensor, and/or a detection result of a motion sensor.

Methods for notification management between an electronic device and a wearable electronic device may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for notification management between an electronic device and a wearable electronic device of the invention;

FIG. 2 is a schematic diagram illustrating an embodiment of an electronic device of the invention;

FIG. 3 is a schematic diagram illustrating an embodiment of a wearable electronic device of the invention;

FIG. 4 is a flowchart of an embodiment of a method for notification management between an electronic device and a wearable electronic device of the invention;

FIG. 5 is a flowchart of another embodiment of a method for notification management between an electronic device and a wearable electronic device of the invention; and

FIG. 6 is a flowchart of an embodiment of a method for managing notification data in a wearable electronic device of the invention.

### DETAILED DESCRIPTION OF THE INVENTION

Methods and systems for notification management between an electronic device and a wearable electronic device are provided.

FIG. 1 is a schematic diagram illustrating an embodiment of a system for notification management between an electronic device and a wearable electronic device of the invention. The system for notification management between an electronic device and a wearable electronic device comprise an electronic device 110 and a wearable electronic device 120. In some embodiments, the electronic device 110 may be a portable device, such as a mobile phone, a smart phone, a PDA (Personal Digital Assistant), a GPS (Global Positioning System), a notebook, or a tablet computer. In some embodiments, the electronic device 110 can connect to the wearable electronic device 120 via a wireless network 130, such as Wi-Fi or Bluetooth network.

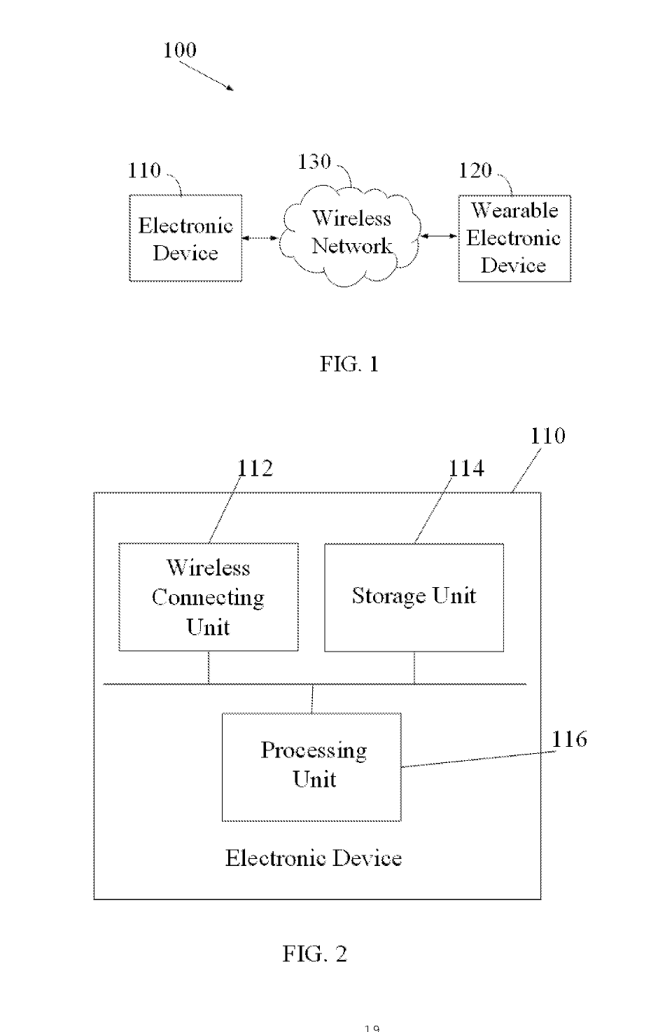

FIG. 2 is a schematic diagram illustrating an embodiment of an electronic device of the invention. As described, the electronic device may be a portable device, such as a mobile phone, a smart phone, a PDA, a GPS, a notebook, or a tablet computer. As shown in FIG. 2, the electronic device 110 comprises a wireless connecting unit 112, a storage unit 114, and a processing unit 116. The wireless connecting unit 112 can connect to other electronic devices having wireless connecting capabilities via a wireless network, such as Wi-Fi or Bluetooth network. The storage unit 114 can store related data. The processing unit 116 can control related operations of hardware and software in the electronic device 110, and perform the methods for notification management between an electronic device and a wearable electronic device of the invention. This will be discussed further in the following paragraphs. It is understood that, in some embodiments, the electronic device 110 can further comprise a display unit (not shown in FIG. 2) for displaying related information, such as images, interfaces, and related data. The electronic device 110 can install an operating system and a plurality of applications, wherein the respective applications can be executed under the control of the operating system. It is noted that, in some embodiments, the operating system can provide a status bar for displaying notification contents for the respective applications in the electronic device. It is noted that, the notification contents may comprise texts and/or icons. The status bar can be displayed via the display unit. It is understood that, the status bar may be also called ‘notification bar’ in some electronic devices.

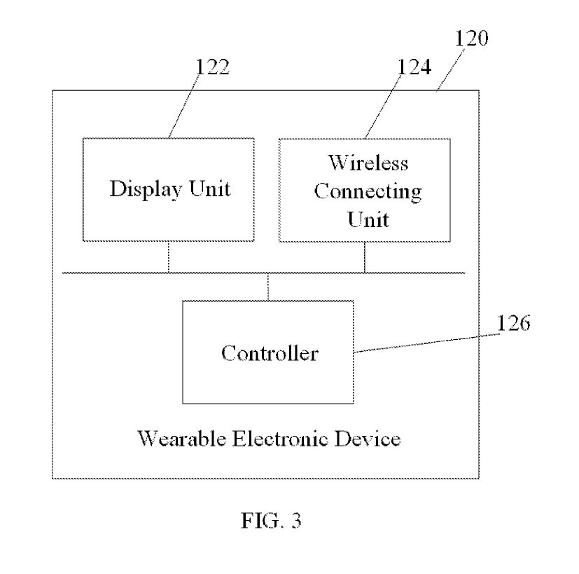

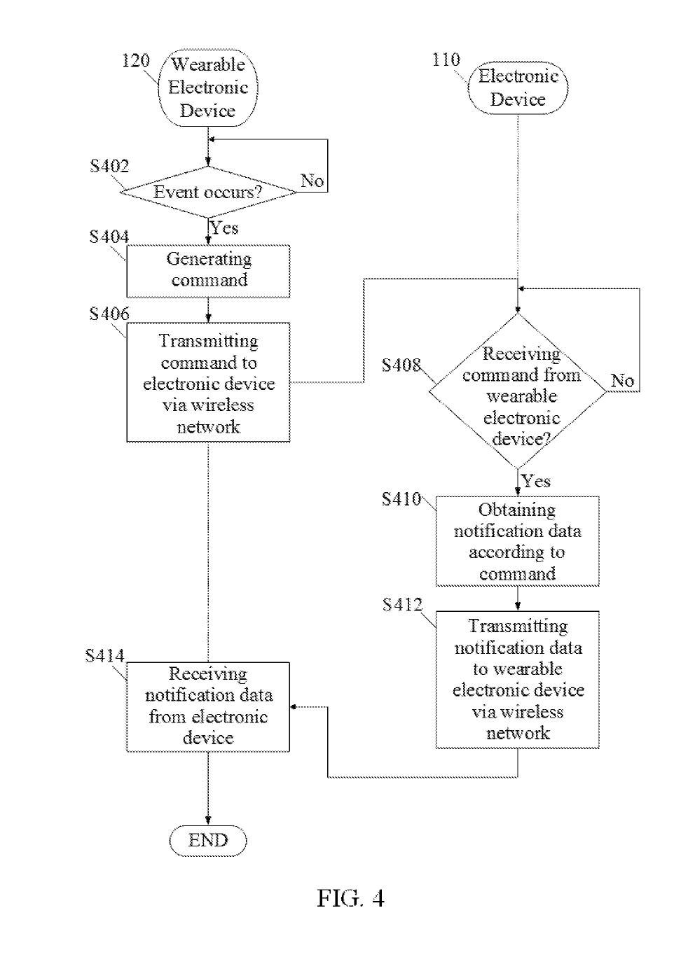

FIG. 3 is a schematic diagram illustrating an embodiment of a wearable electronic device of the invention. As shown in FIG. 3, the wearable electronic device 120 comprises a display unit 122, a wireless connecting unit 124, and a controller 126. The display unit 122 can display related data, such as texts, images, and interfaces. The wireless connecting unit 124 can connect to other electronic devices, such as the electronic device 110 having wireless connecting capabilities via a wireless network, such as Wi-Fi or Bluetooth network. The controller 126 can control related operations of hardware and software in the wearable electronic device 120, and perform the methods for notification management between an electronic device and a wearable electronic device of the invention, which will be discussed in the following paragraphs.

It is understood that, in some embodiments, the wearable electronic device 120 can comprise at least one motion sensor (not shown in FIG. 3) for detecting the motion of the wearable electronic device 120. It is understood that, in some embodiments, the motion sensor may be an accelerometer such as a G-sensor for generating information of velocity and displacement when the device moves. In some embodiments, the motion sensor may be a Gyro sensor for generating information of angular acceleration when the device moves. It is noted that, the above motion sensors are only examples of the present application, and the present invention is not limited thereto. Any motion sensor which can detect the motion of the wearable electronic device can be applied in the present invention. In some embodiments, the wearable electronic device 120 can comprise at least one input unit, such as a touch-sensitive screen and/or a physical key for receiving an input to the wearable electronic device 120 from a user. In some embodiments, the wearable electronic device 120 can comprise a proximity sensor for detecting a presence of an object.

FIG. 4 is a flowchart of an embodiment of a method for notification management between an electronic device and a wearable electronic device of the invention. The method for notification management between an electronic device and a wearable electronic device can be used in a wearable electronic device 120 and an electronic device 110, such as a mobile phone, a smart phone, a PDA, a GPS, a notebook, a tablet computer, or other portable device.

In step S402, it is determined whether an event occurs in the wearable electronic device 120. It is understood that, in some embodiments, the event may be a reception of an input by the wearable electronic device via an input unit. For example, when a touch of an object is detected by a touch-sensitive screen of the wearable electronic device, it is determined that an event occurs in the wearable electronic device. In an example, when a physical key of the wearable electronic device is pressed, it is determined that an event occurs in the wearable electronic device. In another example, when a specific motion generated by the wearable electronic device is detected by a motion sensor of the wearable electronic device, it is determined that an event occurs in the wearable electronic device. In a further example, when a presence of an object is detected by a proximity sensor of the wearable electronic device, it is determined that an event occurs in the wearable electronic device. In some embodiments, the event may be an activation for a component of the wearable electronic device. For example, when a display unit of the wearable electronic device is activated to display, it is determined that an event occurs in the wearable electronic device. In another example, when a vibration unit of the wearable electronic device is activated to vibrate, it is determined that an event occurs in the wearable electronic device. It is noted that, the above events are only examples of the present application, and the present invention is not limited thereto. When no event occurs in the wearable electronic device 120 (No in step S402), the procedure remains at step S402. When an event occurs in the wearable electronic device 120 (Yes in step S402), in step S404, the wearable electronic device 120 generates a command, and in step S406, transmits the command to the electronic device 110 via a wireless network, such as Wi-Fi or Bluetooth network.

In step S408, the electronic device 110 determines whether a command is received from the wearable electronic device 120. When the electronic device 110 does not receive a command from the wearable electronic device 120 (No in step S408), the procedure remains at step S408. When the electronic device 110 receives a command from the wearable electronic device 120 (Yes in step S408), in step S410, the electronic device 110 obtains notification data according to the received command. It is understood that, in some embodiments, the notification data can be obtained from a status bar of the electronic device 110. As described, the electronic device 110 can install an operating system and a plurality of applications, wherein the respective applications can be executed under the control of the operating system. The operating system can provide a status bar for displaying notification contents for the respective applications in the electronic device 110. In some embodiments, the electronic device 110 can provide an interface for selecting at least one specific application from the applications in the electronic device 110, wherein when the status bar comprises the notification content corresponding to the specific application, the electronic device obtains the notification content corresponding to the specific application as the notification data. After the notification data is obtained, in step S412, the electronic device 110 transmits the notification data to the wearable electronic device 120 via the wireless network. At the time, in step S414, the wearable electronic device 120 receives the notification data from the electronic device 110 via the wireless network.

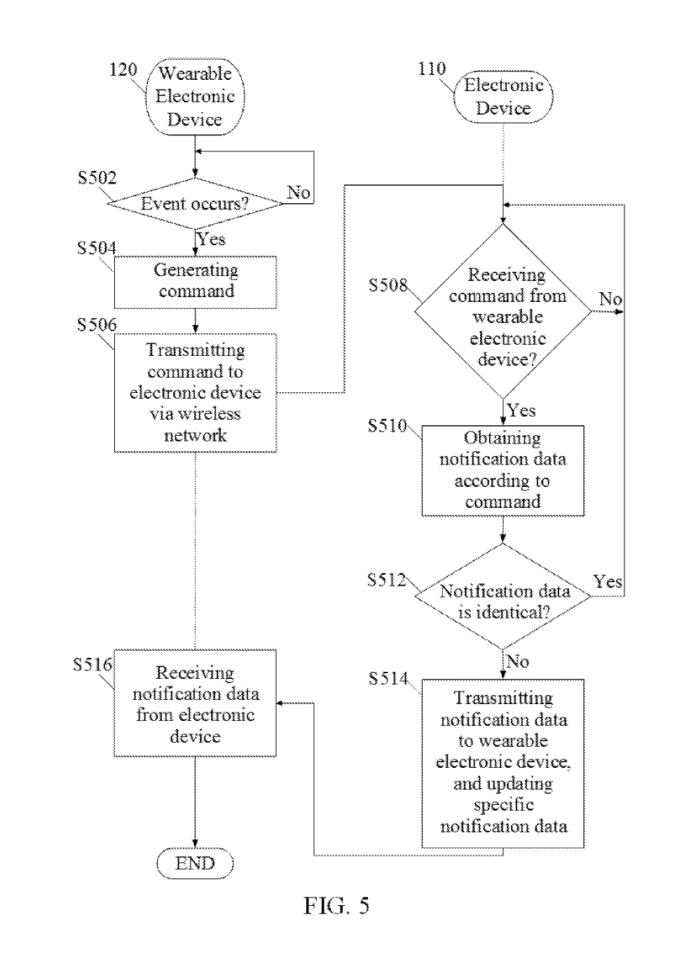

FIG. 5 is a flowchart of another embodiment of a method for notification management between an electronic device and a wearable electronic device of the invention. The method for notification management between an electronic device and a wearable electronic device can be used in a wearable electronic device 120 and an electronic device 110, such as a mobile phone, a smart phone, a PDA, a GPS, a notebook, a tablet computer, or other portable device.

In step S502, it is determined whether an event occurs in the wearable electronic device 120. Similarly, in some embodiments, the event may be a reception of an input by the wearable electronic device via an input unit. For example, when a touch of an object is detected by a touch-sensitive screen of the wearable electronic device, it is determined that an event occurs in the wearable electronic device. In an example, when a physical key of the wearable electronic device is pressed, it is determined that an event occurs in the wearable electronic device. In another example, when a specific motion generated by the wearable electronic device is detected by a motion sensor of the wearable electronic device, it is determined that an event occurs in the wearable electronic device. In a further example, when a presence of an object is detected by a proximity sensor of the wearable electronic device, it is determined that an event occurs in the wearable electronic device. In some embodiments, the event may be an activation for a component of the wearable electronic device. For example, when a display unit of the wearable electronic device is activated to display, it is determined that an event occurs in the wearable electronic device. In another example, when a vibration unit of the wearable electronic device is activated to vibrate, it is determined that an event occurs in the wearable electronic device. It is noted that, the above events are only examples of the present application, and the present invention is not limited thereto. When no event occurs in the wearable electronic device 120 (No in step S502), the procedure remains at step S502. When an event occurs in the wearable electronic device 120 (Yes in step S502), in step S504, the wearable electronic device 120 generates a command, and in step S506, transmits the command to the electronic device 110 via a wireless network, such as Wi-Fi or Bluetooth network.

In step S508, the electronic device 110 determines whether a command is received from the wearable electronic device 120. When the electronic device 110 does not receive a command from the wearable electronic device 120 (No in step S508), the procedure remains at step S508. When the electronic device 110 receives a command from the wearable electronic device 120 (Yes in step S508), in step S510, the electronic device 110 obtains notification data according to the received command. Similarly, in some embodiments, the notification data can be obtained from a status bar of the electronic device 110. As described, the electronic device 110 can install an operating system and a plurality of applications, wherein the respective applications can be executed under the control of the operating system. The operating system can provide a status bar for displaying notification contents for the respective applications in the electronic device 110. In some embodiments, the electronic device 110 can provide an interface for selecting at least one specific application from the applications in the electronic device 110, wherein when the status bar comprises the notification content corresponding to the specific application, the electronic device obtains the notification content corresponding to the specific application as the notification data. After the notification data is obtained, in step S512, the electronic device 110 determines whether the obtained notification data is identical to specific notification data. It is understood that, in some embodiments, the electronic device 110 can record the notification data which has been transmitted to the wearable electronic device 120. The specific notification data is the notification data which are recently transmitted to the wearable electronic device 120 by the electronic device 110. When the obtained notification data is identical to the specific notification data (Yes in step S512), the procedure returns to step S508. That is the electronic device 120 does not transmit the notification data to the wearable electronic device 120. When the obtained notification data is not identical to the specific notification data (No in step S512), in step S514, the electronic device 110 transmits the notification data to the wearable electronic device 120 via the wireless network, and sets the notification data as the specific notification data, thereby updating the specific notification data. At the time, in step S516, the wearable electronic device 120 receives the notification data from the electronic device 110 via the wireless network.

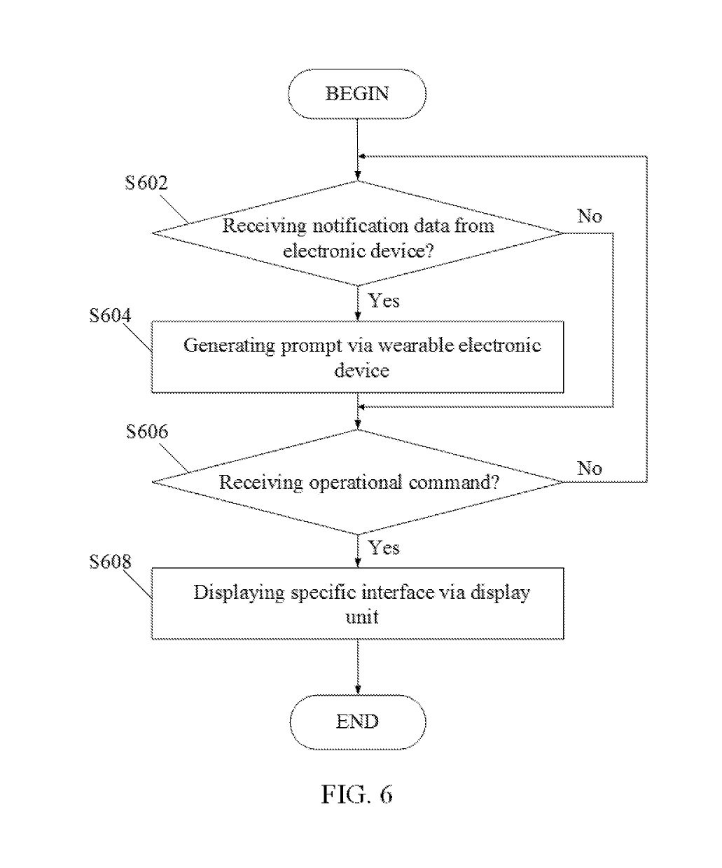

FIG. 6 is a flowchart of an embodiment of a method for managing notification data in a wearable electronic device of the invention. The method for managing notification data in a wearable electronic device of the invention can be used in a wearable electronic device.

In step S602, the wearable electronic device 120 determines whether notification data is received from the electronic device 110 via a wireless network, such as Wi-Fi or Bluetooth network. When the wearable electronic device 120 does not receive notification data from the electronic device 110 (No in step S602), the procedure goes to step S606. When the wearable electronic device 120 receives notification data from the electronic device 110 (Yes in step S602), in step S604, a prompt is generated via the wearable electronic device 120. It is understood that, in some embodiments, the prompt can comprise a vibration, and/or data, such as texts, numbers, indications or images displayed in a display unit of the wearable electronic device. Then, in step S606, it is determined whether an operational command is received by the wearable electronic device 120. It is understood that, in some embodiments, the operational command comprises an input corresponding to an input unit, such as a contact on a touch-sensitive screen, or a press of a physical key. In some embodiments, the operational command comprises a detection result for an object of a proximity sensor. In some embodiments, operational command comprises a detection result of a motion sensor. It is noted that, the above operational commands are only examples of the present application, and the present invention is not limited thereto. When the operational command is not received (No in step S606), the procedure returns to step 5602. When the operational command is received (Yes in step S606), in step 5608, in response to the operational command, a specific interface is displayed via a display unit of the wearable electronic device 120, and the notification data is displayed in the specific interface. It is noted that, in the embodiment, when the wearable electronic device 120 receives the notification data from the electronic device 110, the notification data will be not directly displayed via the display unit of the wearable electronic device 120. Only when the wearable electronic device 120 receives the operational command, the specific interface comprising the notification data is displayed.

Therefore, the methods and systems for notification management between an electronic device and a wearable electronic device of the present invention can appropriately manage the notifications between an electronic device, such as a smart phone and a wearable electronic device, thereby realizing smart communications and further improving power management between devices.

Methods for notification management between an electronic device and a wearable electronic device may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for notification management between an electronic device and a wearable electronic device for use in an electronic device and a wearable electronic device, comprising:
when an event occurs in the wearable electronic device, generating a command by the wearable electronic device;
transmitting the command to the electronic device via a wireless network by the wearable electronic device;
obtaining notification data according to the command by the electronic device; and
transmitting the notification data to the wearable electronic device via the wireless network by the electronic device.

2. The method of claim 1, wherein the event comprises a reception of an input by the wearable electronic device via an input unit, or an activation for a component of the wearable electronic device.

3. The method of claim 1, further comprising:
recording specific notification data which has been transmitted to the wearable electronic device by the electronic device; and
determining whether the obtained notification data is identical to the specific notification data by the electronic device,
wherein the electronic device does not transmit the notification data to the wearable electronic device when the obtained notification data is identical to the specific notification data, and the electronic device transmits the notification data to the wearable electronic device, and sets the notification data as the specific notification data when the obtained notification data is not identical to the specific notification data.

4. The method of claim 1, wherein the notification data is obtained from a status bar of the electronic device, wherein the status bar displays notification contents for at least one of a plurality of applications in the electronic device.

5. The method of claim 4, further comprising a step of providing an interface for selecting at least one specific application from the applications, wherein when the status bar comprises the notification content corresponding to the specific application, the electronic device obtains the notification content corresponding to the specific application as the notification data.

6. The method of claim 1, further comprising a step of generating a prompt via the wearable electronic device when the wearable electronic device receives the notification data from the electronic device, wherein the prompt comprises a vibration, or data displayed in a display unit of the wearable electronic device.

7. The method of claim 1, further comprising:
receiving an operational command by the wearable electronic device; and
in response to the operational command, displaying a specific interface via a display unit of the wearable electronic device, and displaying the notification data in the specific interface.

8. The method of claim 7, wherein the operational command comprises an input corresponding to an input unit, a detection result for an object of a proximity sensor, or a detection result of a motion sensor.

9. A system for notification management between an electronic device and a wearable electronic device, comprising:
a wearable electronic device generating a command by the wearable electronic device when an event occurs in the wearable electronic device, and transmitting the command to the electronic device via a wireless network; and
an electronic device obtaining notification data according to the command, and transmitting the notification data to the wearable electronic device via the wireless network.

10. A machine-readable storage medium comprising a computer program, which, when executed, causes a device to perform a method for notification management between an electronic device and a wearable electronic device, wherein the method comprises:
when an event occurs in a wearable electronic device, generating a command by the wearable electronic device;
transmitting the command to an electronic device via a wireless network by the wearable electronic device;
obtaining notification data according to the command by the electronic device; and
transmitting the notification data to the wearable electronic device via the wireless network by the electronic device.
